(19) United States
(12) Patent Application Publication
(10) Pub. No.: US 2014/0291174 A1
(43) Pub. Date: Oct. 2, 2014

(54) TABLET COMPUTER COVER AND STAND

(71) Applicant: Chanseol Chung, Hollywood, FL (US)

(72) Inventor: Chanseol Chung, Hollywood, FL (US)

(73) Assignee: MARWARE, INC, HOLLYWOOD, FL (US)

(21) Appl. No.: 13/854,531

(22) Filed: Apr. 1, 2013

(51) Int. Cl. G06F 1/16

(52) U.S. Cl. CPC G06F 1/1656
USPC 206/45.23

(57) ABSTRACT

A tablet computer cover and stand includes a front cover and a rear cover interconnected by a cover hinge and configured to enclose a tablet computer therebetween in a closed condition. The front and rear covers have respective inner and outer surfaces and the inner surface of the front cover has at least one stop. A shell is connected to the rear cover by a shell hinge and is configured to hold the tablet computer. The shell has an extension configured to engage the stop upon opening the front and rear covers about the cover hinge and rotating the shell about the shell hinge from the closed condition to a lower stand position. The shell can be adjusted into infinitely variable positions for carrying out applications on the tablet computer.

### BACKGROUND OF THE INVENTION

1. Field of the Invention

The invention relates to a tablet computer cover and stand, which is adjustable into different positions.

2. Description of the Related Art

A tablet computer is a one-piece, mobile computer which typically has a touch screen. Tablet computers, such as the iPad®, are monolithic devices which, unlike laptop computers, require a stand to hold them in a comfortable position for viewing or typing. They also are subject to soiling, wear and damage due to shocks and therefore require covers for protection.

Many prior art devices provide such functions, but are generally only movable into two positions and therefore do not permit the tablet computer to be displayed in several different positions which are required for the many applications for which they are used, such as typing, watching videos and delivering presentations to a group.

### BRIEF SUMMARY OF THE INVENTION

It is accordingly an object of the invention to provide a tablet computer cover and stand, which overcomes the above-mentioned disadvantages of the heretofore-known devices of this general type and which permits a tablet computer to be displayed in several varied positions which are required for different applications.

With the foregoing and other objects in view there is provided, in accordance with the invention, a tablet computer cover and stand, comprising a front cover and a rear cover interconnected by a cover hinge, such as a living hinge, and configured to enclose a tablet computer therebetween in a closed condition. The front and rear covers have respective inner and outer surfaces and the inner surface of the front cover has at least one stop. A shell is connected to the rear cover by a shell hinge and is configured to hold the tablet computer. The shell has an extension configured to engage the at least one stop upon opening the front and rear covers about the cover hinge and rotating the shell about the shell hinge from the closed condition to a lower stand position. The rear cover may have an opening for access to a camera lens of the tablet computer permitting use of the camera. The stop may include one or more grooves, slots or bumps permitting the computer to be displayed at different viewing angles. Thus, according to the invention, the computer may be protected against damage and soiling and may be displayed at different viewing angles by using one and the same cover and stand.

In accordance with another feature of the invention, the extension is hinged to the shell. This permits the shell holding the computer to be pivoted away from the extension.

In accordance with a further feature of the invention, arms are hinged to the rear cover and the shell to permit the shell holding the tablet computer to be lifted from the lower stand position into infinitely adjustable positions and to permit the shell holding the tablet computer to be lifted into an elevated stand position. The shell may have rails to which the arms are hinged. Thus, the user of the computer can choose virtually any viewing angle and an elevated presentation position.

In accordance with an added feature of the invention, a kick stand can be rotated away from the inner surface of the front cover about a hinge position to support the tablet computer cover and stand in a vertical standing position after rotating the outer surfaces of the front and rear covers against each other about the cover hinge. The inner surface of the front cover may have a recess formed therein for receiving the kick stand. Therefore, the computer can be displayed in the portrait orientation as well as the landscape orientation.

In accordance with an additional feature of the invention, hooks are disposed on one of the covers, straps are spring-loaded for retraction into the other of the covers and a closure tab is attached to the straps and configured to be engaged behind the hooks for locking the computer cover and stand in the closed condition. This provides security against the cover accidentally opening and being susceptible to damage and soiling.

In accordance with a concomitant feature of the invention, the shell has feet to be engaged, secured or locked into lower holes in the extension in the lower stand position or into upper holes in the extension in the elevated stand position. Similarly, the extension has feet to be engaged, secured or locked into holes in the inner surface of the rear cover in the closed condition. Pairs of feet and holes are usually provided to hold the parts of the device in place without play.

Other features which are considered as characteristic for the invention are set forth in the appended claims.

Although the invention is illustrated and described herein as embodied in a tablet computer cover and stand, it is nevertheless not intended to be limited to the details shown, since various modifications and structural changes may be made therein without departing from the spirit of the invention and within the scope and range of equivalents of the claims.

The construction of the invention, however, together with additional objects and advantages thereof will be best understood from the following description of the specific embodiment when read in connection with the accompanying drawings.

### BRIEF DESCRIPTION OF THE SEVERAL VIEWS OF THE DRAWING

FIGS. 1-4 are diagrammatic, front-elevational, side-elevational, rear-elevational and front-perspective views respectively showing a tablet computer cover and stand according to the invention, in a closed condition with a shell for holding a tablet computer disposed therein;

FIGS. 5 and 6 are front-perspective views showing the operation of a closure tab of the tablet computer cover and stand;

FIGS. 7 and 8 are respective side-perspective and side-elevational views showing the shell lifted from a folio cover of the tablet computer cover and stand;

FIGS. 9 and 10 are respective side-perspective and side-elevational views showing the tablet computer cover and stand in a lower or regular stand position;

FIGS. 11-13 are respective side-perspective, rear-perspective and side-elevational views showing the tablet computer cover and stand lifted from the lower or regular stand position;

FIGS. 14-16 are respective front-perspective, rear-perspective and side-elevational views showing the tablet computer cover and stand in an elevated stand position; and

FIGS. 17-19 are respective front-perspective, rear-perspective and side-elevational views showing the tablet computer cover and stand flipped back into a vertical stand position.

### DETAILED DESCRIPTION OF THE INVENTION

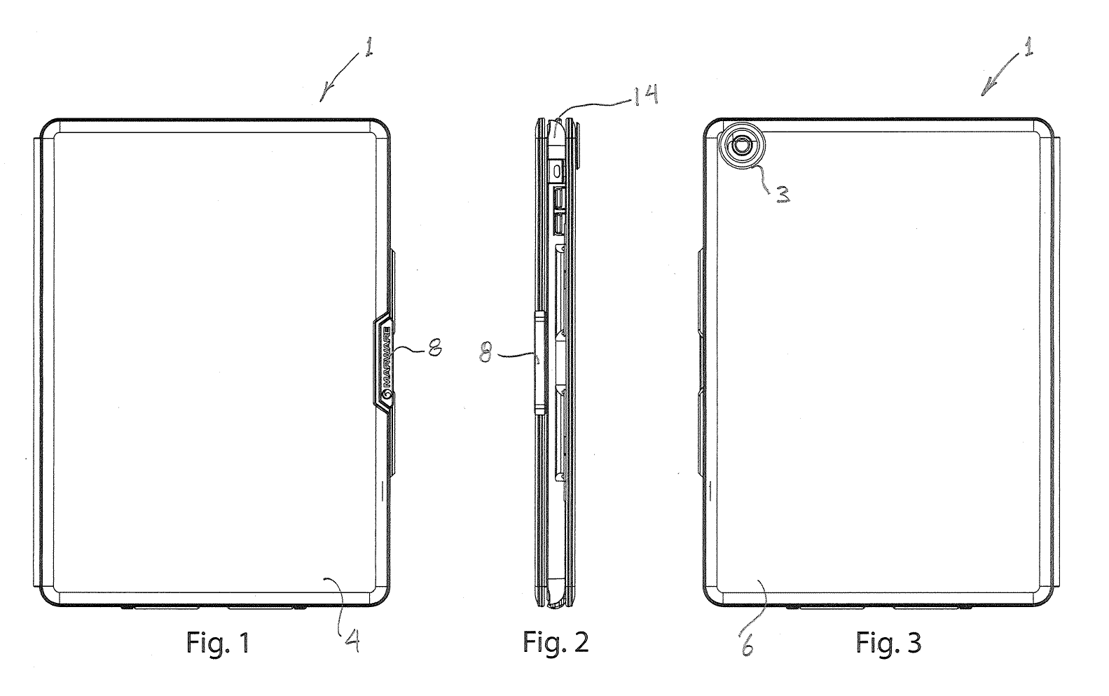

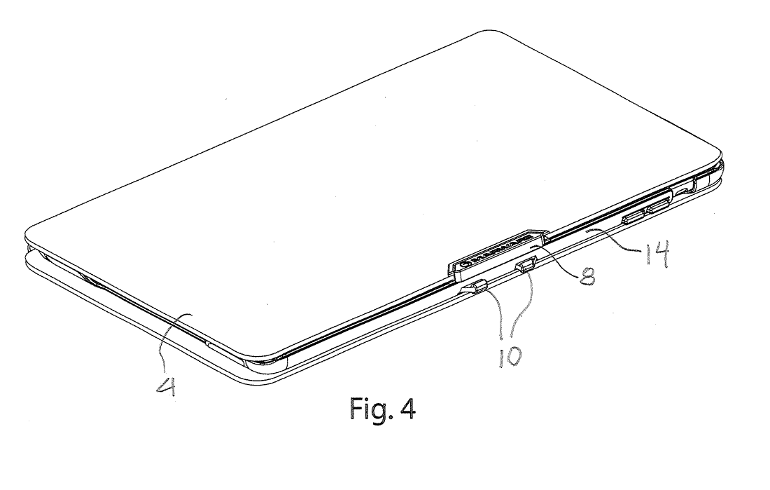

Referring now to the figures of the drawing in detail and first, particularly, to FIGS. 1-4 thereof, there is seen a tablet computer cover and stand 1 in a closed condition. The cover and stand 1 includes a front folio cover 4 and a rear folio cover 6 surrounding a shell 14 for holding a tablet computer, as well as a closure tab 8 for locking the covers 4, 6 together. The closure tab 8 is shown in a retracted and open position in FIG. 4, in which it is released from hooks 10. The outer surface of the rear cover 6 has an opening 3, such as for access to a camera lens of the tablet computer.

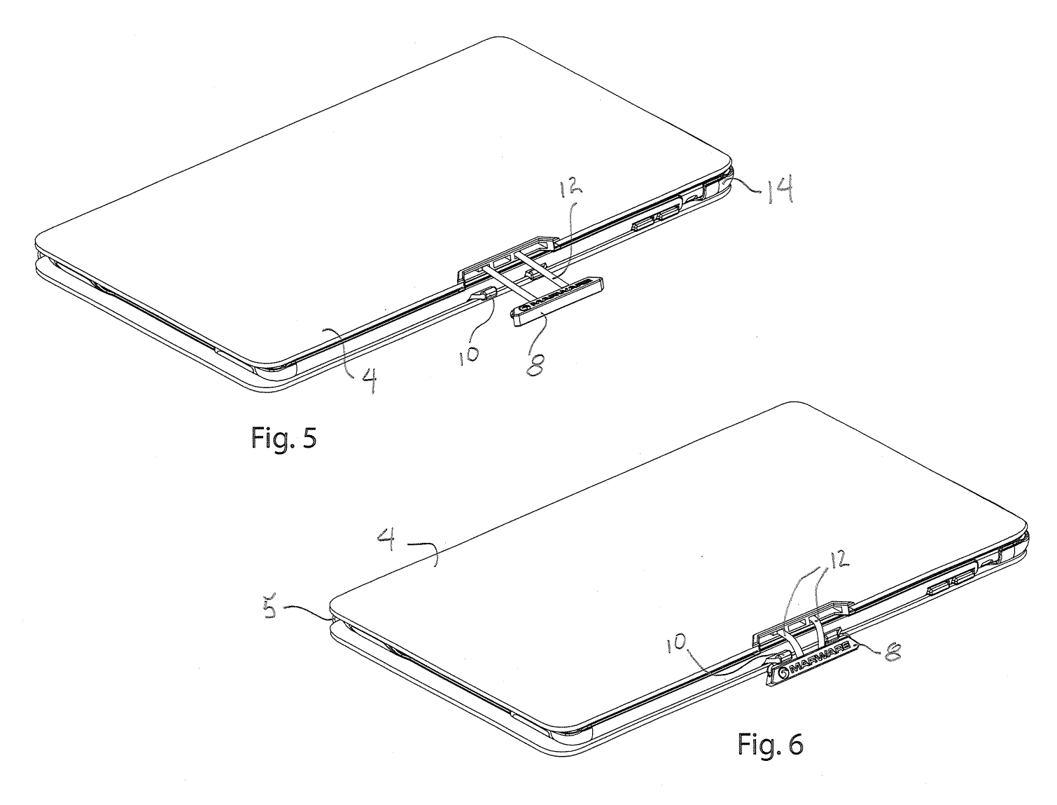

FIGS. 5 and 6 show that the closure tab 8 is attached to straps 12 which are guided through slots in the front folio cover 4 and are spring-loaded to pull the straps and therefore the closure tab 8 towards the front folio cover 4. The closure tab 8 is operated by pulling the closure tab 8 and extracting the straps 12 as shown in FIG. 5 and locking the closure tab 8 below the hooks 10 as shown in FIG. 6.

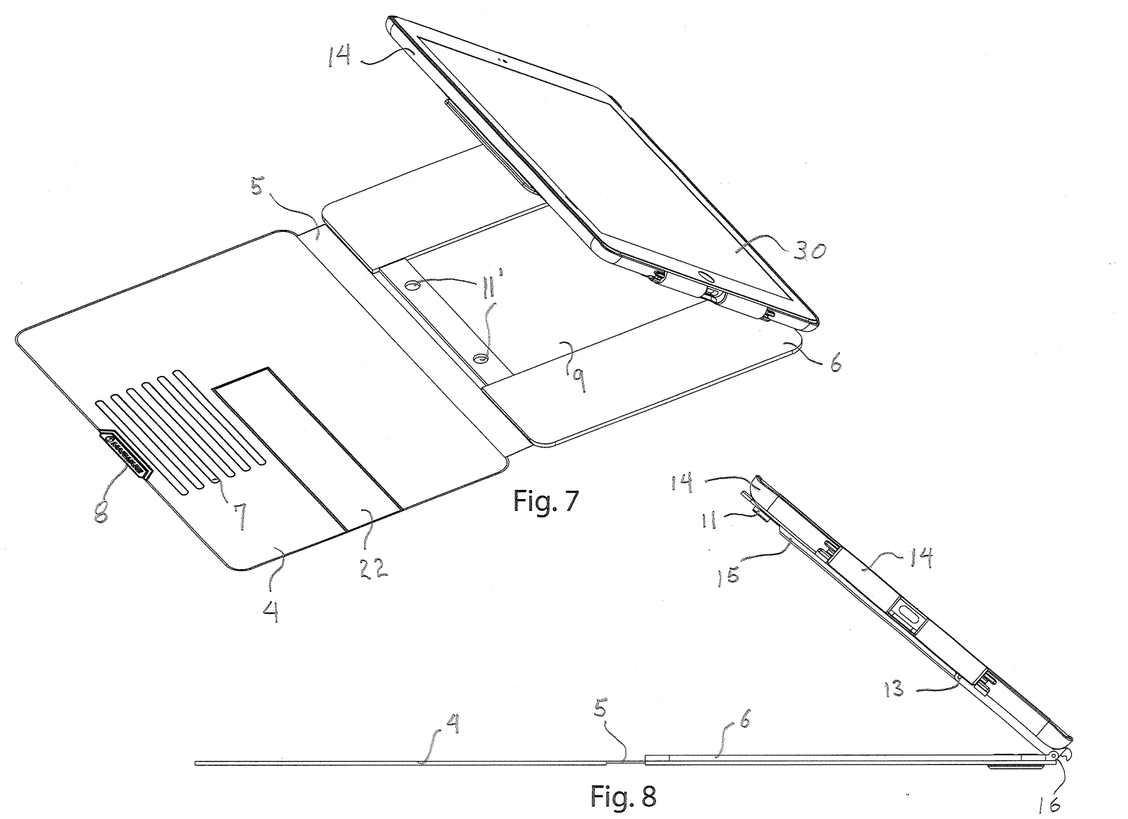

FIGS. 7 and 8 show the cover and stand 1 in an open condition, from which it can be seen that the front and rear covers 4, 6 are interconnected by a living cover hinge 5 and that the shell 14 holds a tablet computer 30 and may be lifted from the rear folio cover 6 about a shell hinge 16.

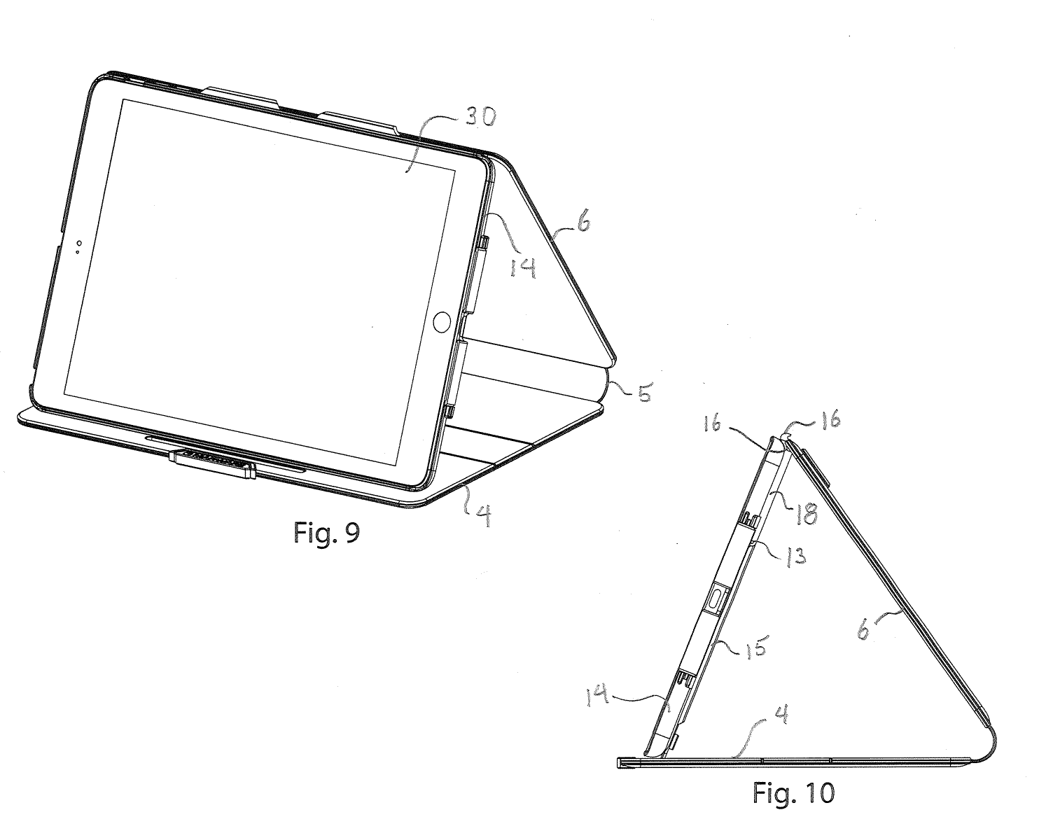

As is seen in FIGS. 8 and 10, an extension 15 is connected to the shell 14 at a hinge 13. FIGS. 9 and 10 show the cover and stand 1 rotated from the position shown in FIGS. 7 and 8 about the living or live hinge 5, until an end of the extension 15 of the shell 14 engages in one of several stops (although only one stop may be provided) configured as grooves or slots 7 formed in the inner surface of the front folio cover 4. Bumps or protrusions 7 may be used as the stops instead of grooves or slots 7. The tablet computer cover and stand is then in a lower or regular stand position. FIGS. 7 and 8 also show that the extension 15 enters a recess 9 and feet 11 on the extension enter blind holes 11′ in the inner surface of the rear cover 6, in the closed condition.

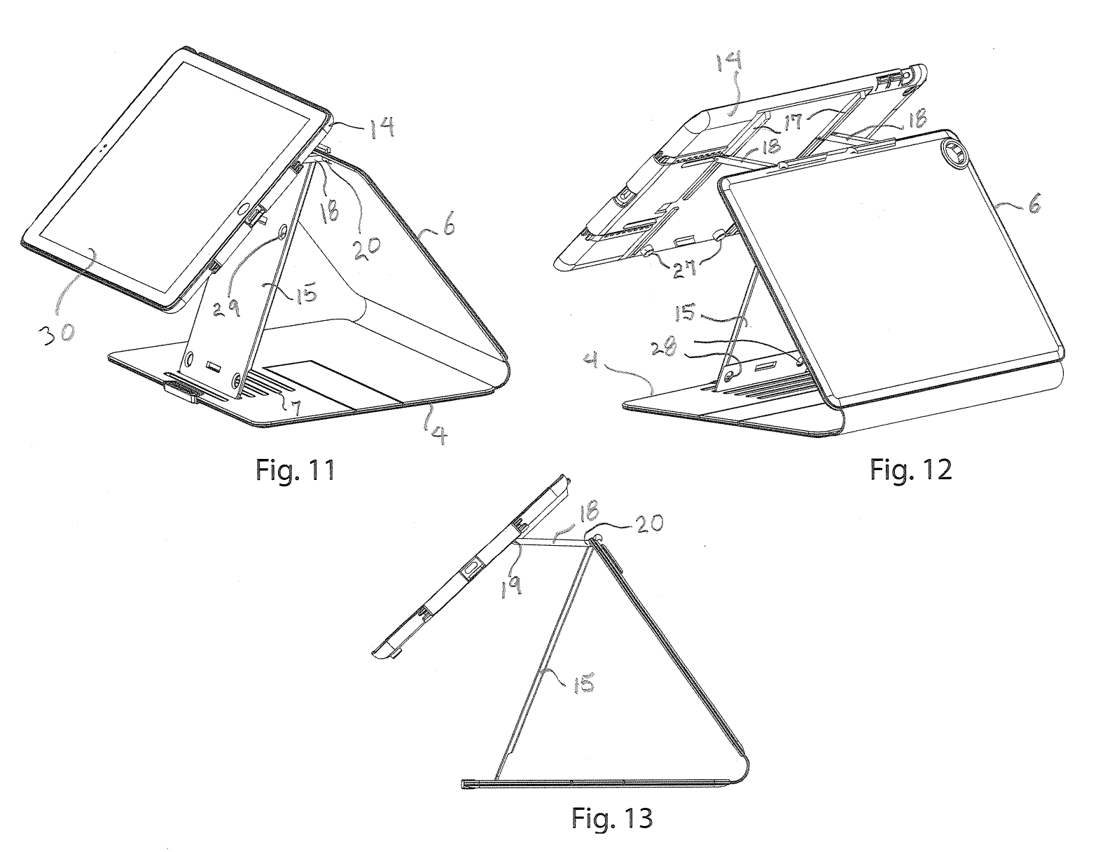

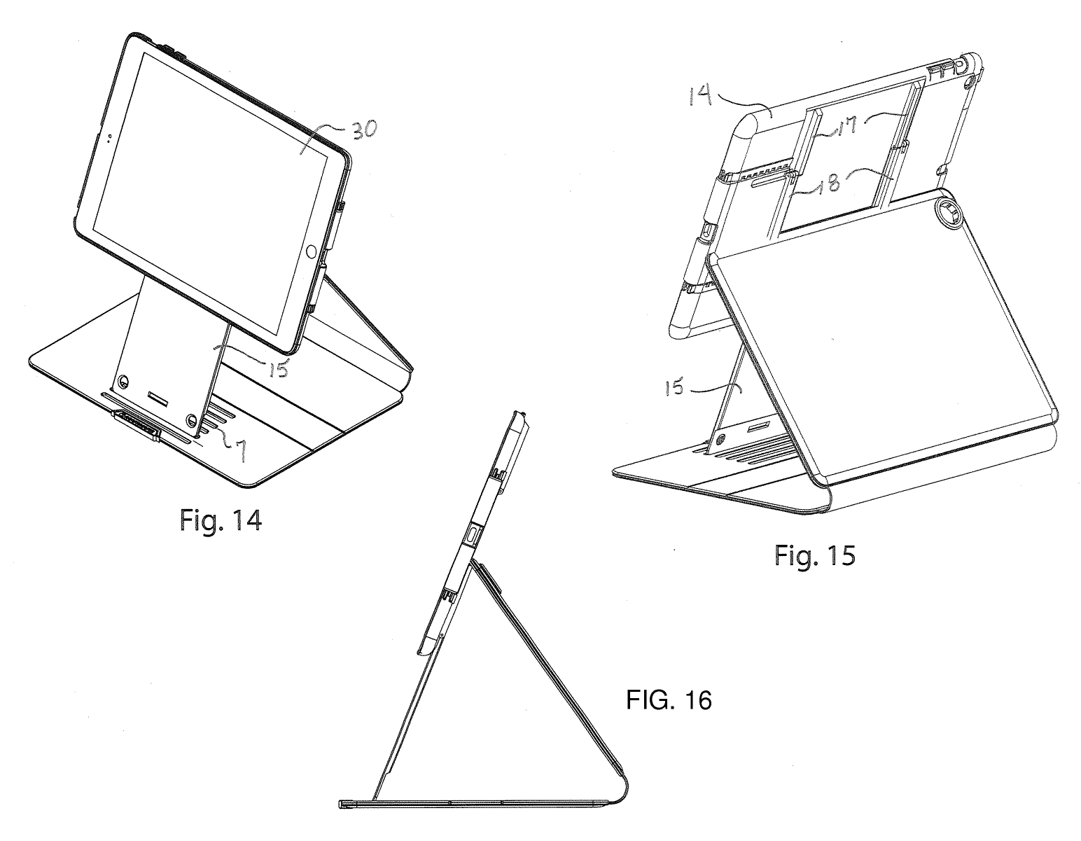

FIGS. 11-13 show that the shell 14 has rails 17. Arms 18 each have one end connected to the rails 17 at hinges 19 and another end connected to the rear folio cover 6 at hinges 20. Thus, with the extension 15 still engaged at a groove, slot or bumps 7, the shell 14 may be moved from the lower or regular stand position show in FIGS. 9 and 10 into a lifted stand position shown in FIGS. 11-13. It must be noted that the positional adjustment of the shell 14 and thus of the computer 30 is infinite due to the different positions of the extension 15 and the infinitely adjustable positions of the arms 18. If the shell 14 is pushed upward and flat against the extension 15 about the arms 18 from the lifted stand position shown in FIGS. 11-13 to its uppermost position, it reaches an elevated stand position shown in FIGS. 14-16. A hook 26 prevents over-rotation.

The shell 14 has a pair of feet 27 which are locked into a lower pair of blind holes 28 in the extension 15 in the lower or regular stand position shown in FIGS. 9 and 10 or into an upper pair of holes 29 in the extension 15 in the elevated stand position shown in FIGS. 14-16.

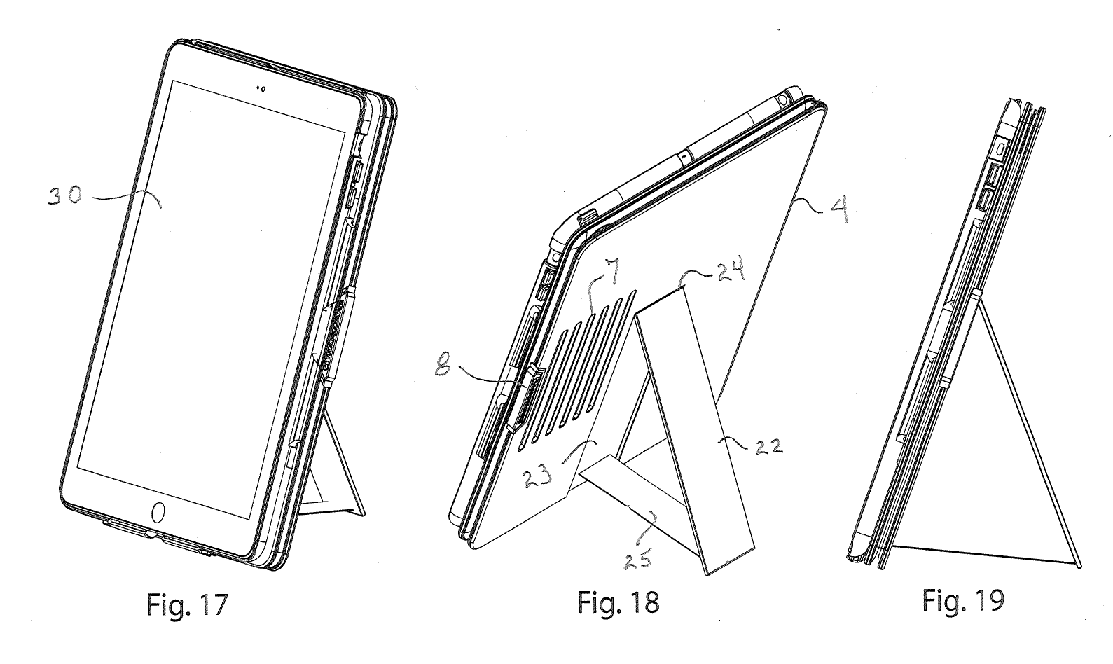

FIGS. 17-19 show the tablet computer cover and stand 1 flipped back into a vertical stand position. This is accomplished by rotating the front folio cover 4 about the hinge 5 until the outer surfaces of the front and rear covers 4, 6 are placed against each other. In that position, the inner surface of the front cover 4 faces outward and a kick stand 22 may be pulled out of a recess 23 about a hinge location 24. The kick stand 22 is held in its pulled-out or extended position shown in FIGS. 17-19 by a nylon strap 25 acting as a stopper.

1. A tablet computer cover and stand, comprising:
a front cover and a rear cover interconnected by a cover hinge and configured to enclose a tablet computer therebetween in a closed condition, said front and rear covers having respective inner and outer surfaces and said inner surface of said front cover having at least one stop; and
a shell connected to said rear cover by a shell hinge and configured to hold the tablet computer, said shell having an extension configured to engage said at least one stop upon opening said front and rear covers about said cover hinge and rotating said shell about said shell hinge from said closed condition to a lower stand position.

2. The tablet computer cover and stand according to claim 1, wherein said extension is hinged to said shell.

3. The tablet computer cover and stand according to claim 1, which further comprises arms hinged to said rear cover and said shell and configured to permit said shell holding the tablet computer to be lifted from said lower stand position into infinitely adjustable positions and to permit said shell holding the tablet computer to be lifted into an elevated stand position.

4. The tablet computer cover and stand according to claim 3, wherein said shell has rails to which said arms are hinged.

5. The tablet computer cover and stand according to claim 1, which further comprises a kick stand configured to be rotated away from said inner surface of said front cover about a hinge position to support the tablet computer cover and stand in a vertical standing position after rotating said outer surfaces of said front and rear covers against each other about said cover hinge.

6. The tablet computer cover and stand according to claim 5, wherein said inner surface of said front cover has a recess formed therein for receiving said kick stand.

7. The tablet computer cover and stand according to claim 1, which further comprises hooks disposed on one of said covers, straps spring-loaded for retraction into the other of said covers and a closure tab attached to said straps and configured to be engaged behind said hooks for locking the computer cover and stand in said closed condition.

8. The tablet computer cover and stand according to claim 3, wherein said shell has feet configured to be engaged into lower holes in said extension in said lower stand position or into upper holes in said extension in said elevated stand position.

9. The tablet computer cover and stand according to claim 1, wherein said extension has feet configured to be engaged into holes in said inner surface of said rear cover in said closed condition.

10. The tablet computer cover and stand according to claim 1, wherein said outer surface of said rear cover has an opening for access to a camera lens of the tablet computer.

11. The tablet computer cover and stand according to claim 1, wherein said cover hinge is a living hinge.

12. The tablet computer cover and stand according to claim 1, wherein said at least one stop is selected from the group consisting of at least one groove, slot or bump.
